(19) United States
(12) Patent Application Publication
(10) Pub. No.: US 2004/0089268 A1
(43) Pub. Date: May 13, 2004

(54) Fuel injection device

(76) Inventors: Achim Brenk, Kaempfelbach-Bilfingen (DE); Wolfgang Klenk, Loechgau (DE); Roland Bleher, Stuttgart (DE); Uwe Gordon, Kemmern (DE); Manfred Mack, Altheim (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/169,984

(22) PCT Filed: Nov. 21, 2001
(86) PCT No.: PCT/DE01/04325

(30) Foreign Application Priority Data
Nov. 21, 2000 (DE) 100 57 683.4

(51) Int. Cl. F02M 1/00

(52) U.S. Cl. 123/446; 123/456

(57) ABSTRACT

In a pressure-controlled fuel injection apparatus (1) with a common rail, an injector (5), and a metering valve (6) for controlling the injector (5), the metering valve (6) is integrated into the common rail. This reduces the production cost for the fuel injection apparatus (1).

### PRIOR ART

The invention relates to a fuel injection apparatus according to the preamble to claim 1.

For better comprehension of the specification and claims, a few terms will be explained below: the fuel injection apparatus according to the invention is embodied as pressure-controlled. In the scope of the invention, the term pressure-controlled fuel injection apparatus is understood to mean that the fuel pressure prevailing in the nozzle chamber of an injector moves a nozzle needle counter to the action of a closing force (spring), thus unblocking the injection opening for an injection of fuel from the nozzle chamber into the cylinder. The pressure at which fuel emerges from the nozzle chamber into a cylinder of the internal combustion engine is referred to as injection pressure, whereas the term system pressure is understood as the pressure at which the fuel inside the fuel injection apparatus is available or stored. Fuel metering refers to supplying a definite quantity of fuel for injection. Leakage is understood to mean a quantity of fuel that is generated during operation of the fuel injection apparatus (e.g. a guidance leakage) that is not used in the injection and is returned to the fuel tank. The pressure level of this leakage can have a standing pressure; the pressure of the fuel is then reduced to the pressure level of the fuel tank.

In common rail systems, the injection pressure can be adapted to the load and speed. For noise reduction, a preinjection is often executed here. In order to reduce emissions, a pressure-controlled injection is known to be favorable.

Currently, pressure-controlled fuel injection apparatuses have metering valves and control modules, which for functional reasons are disposed in the vicinity of the injectors.

### ADVANTAGES OF THE INVENTION

A fuel injection apparatus according to claim 1 is proposed in order to reduce manufacturing costs. Without impairing the hydrodynamic properties, it is possible to integrate the metering valve into the rail in the form of a 3/2-port directional-control valve. The metering valve can be embodied as a module that can be screwed into the common rail housing. The precise machining of the valve seat surfaces can already be executed during production of the module.

The high-pressure sealing of the metering valve is produced by means of a flat sealing surface. The surface pressure can optionally be increased by means of biting edges or biting teeth in order to produce an even better seal. The seal can also be encouraged through the embodiment of a conical valve seat. This also reduces the total amount of space required for the metering valve. For technical grinding reasons, the components of the metering valve and other functional units that are integrated into the common rail should be as rotationally symmetrical as possible.

A corresponding matching of the length of the pressure line from the metering valve to the injector achieves a pressure increase in the nozzle chamber by 20 to 30% in relation to the rail pressure. This pressure increase has a positive effect on the spray formation as well as on the exhaust gas behavior of the motor.

Other functional attachments can be provided, for example a constant-pressure valve, which is disposed in a bore that is preferably situated parallel to the pressure storage chamber. This results in the fact that the fuel between the metering valve and the injector has a definite standing pressure.

The invention is also suitable for common rail systems with a pressure intensifier. In these systems, a scavenging throttle can also be integrated into the common rail housing.

In summary, the invention has the advantage that the complex components, metering valve (solenoid valve), one or more throttles, constant-pressure valve, or pressure intensifier are installed in the common rail housing in the form of modules. This produces a unit, which can constitute a basis for a wide variety of motor types.

### DRAWINGS

Three exemplary embodiments of the fuel injection apparatus according to the invention are shown in a schematic form in the drawings and will be explained in detail in the subsequent description.

FIG. 1 shows a cross section through a first pressure-controlled fuel injection apparatus;

FIG. 2 shows a longitudinal section through the fuel injection apparatus according to FIG. 1;

FIG. 3 shows a detailed enlargement of the high-pressure seal of the metering valve of the fuel injection apparatus according to FIGS. 1 and 2;

FIG. 4 shows a longitudinal section through a second pressure-controlled fuel injection apparatus.

### DESCRIPTION OF THE EXEMPLARY EMBODIMENTS

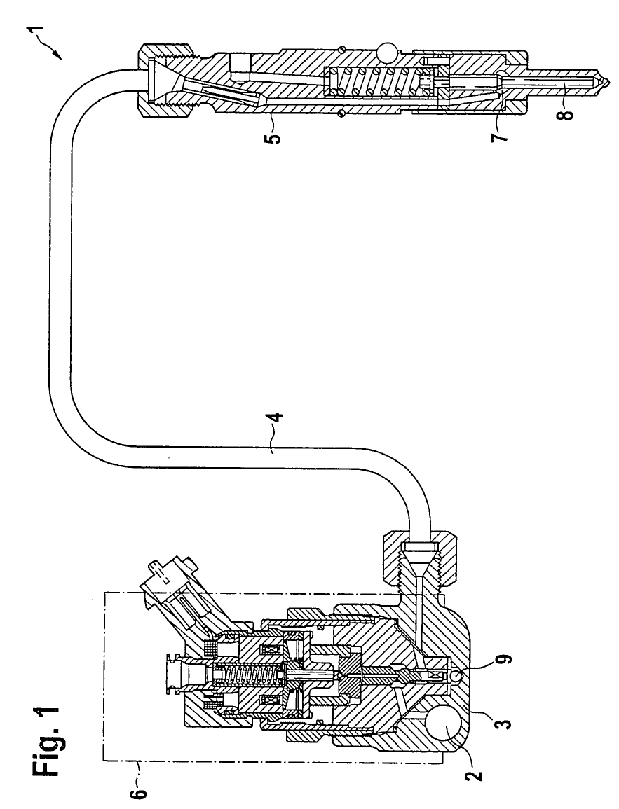

In the pressure-controlled fuel injection apparatus 1 shown in FIG. 1, a quantity-controlled fuel pump that is not shown in the drawing supplies fuel from a storage tank via a supply line into a central pressure storage chamber 2 of a common rail housing 3, from which a number of pressure lines 4, which corresponds to the number of individual cylinders, lead to the individual injectors 5 protruding into the combustion chamber of the internal combustion engine to be supplied. FIG. 1 only shows one of the injectors 5 in detail. The fuel pump serves to generate a system pressure, which is stored in the pressure storage chamber 2 and has a pressure of 300 to approx. 1800 bar.

Metering valves 6 embodied in the form of 3/2-port directional-control valves are flange-mounted to the common rail housing 3. The metering valve 6 is used to produce a pressure-controlled injection for each cylinder. The pressure line 4 connects the pressure storage chamber 2 to a nozzle chamber 7. The injection is executed with the aid of a piston-shaped nozzle needle 8 that can be slid axially in a guide bore and has a conical valve sealing surface at its one end, which cooperates with a valve seat surface on the housing of the injector 5. The injection openings are provided in the valve seat surface of the housing. Inside the nozzle chamber 7, a pressure surface, which points in the opening direction of the nozzle needle 8, is subjected to the pressure prevailing therein, which is supplied to the nozzle chamber 7 by means of the pressure line 4.

After the opening of the metering valve 6, a high-pressure wave of fuel travels in the pressure line 4 to the nozzle chamber 7. The nozzle needle 8 is lifted up from the valve seat surface, counter to a restoring force (closing spring), and the injection process begins.

A bore 9 is integrated into the common rail housing 3 and can likewise be connected to the pressure line 4 by means of the metering valve 6 (standing pressure). The bore 9 is embodied parallel to the pressure storage chamber 2 in the common rail housing 3.

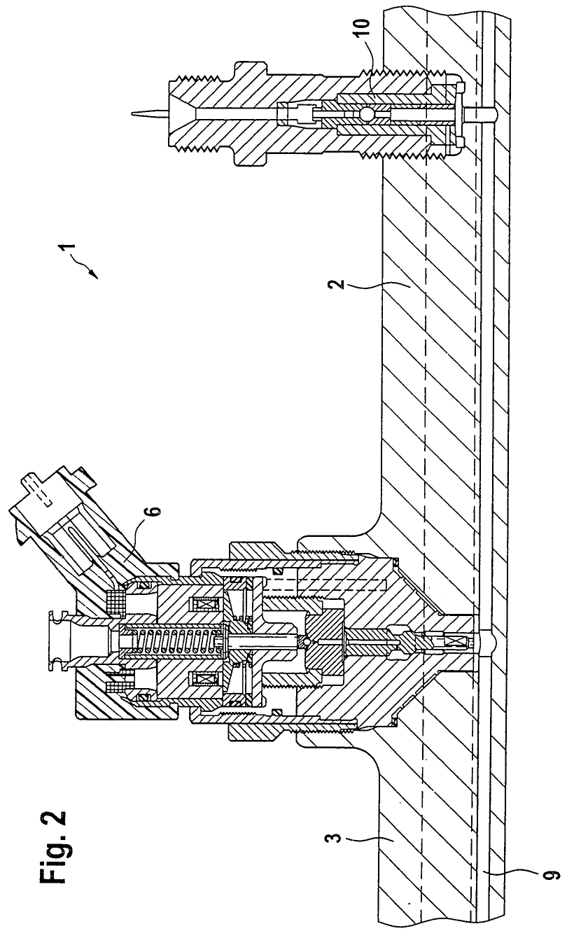

With the aid of the metering valve 6, the nozzle chamber 7 is connected either to the pressure storage chamber 2 for pressure application or to the bore 9 for pressure relief. It is clear from FIG. 2 that the bore 9 disposed parallel to the pressure storage chamber 2 can be closed by means of a constant-pressure valve 10. The pressure inside the bore 9 is regulated to (or maintained at) a constant standing pressure between the metering valve 6 and the injector 5.

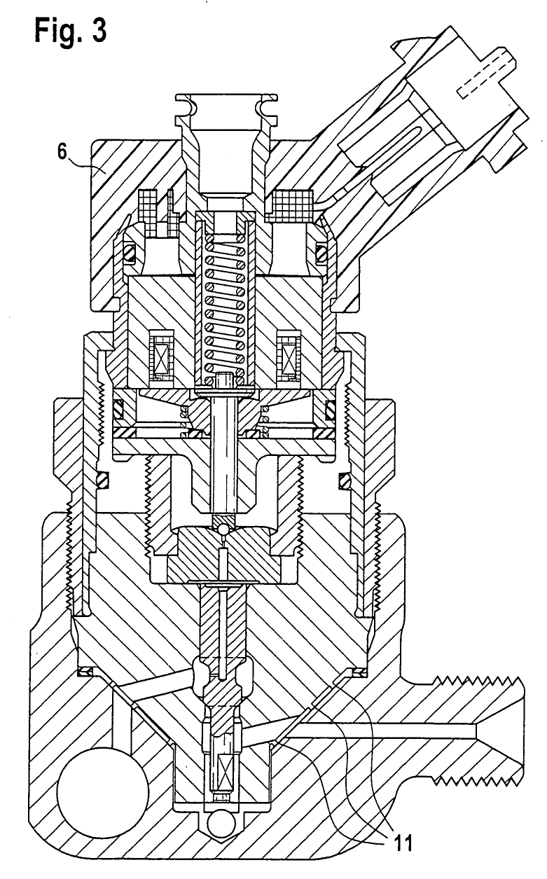

As is shown in FIG. 3, the installation of the metering valve 6 in the vicinity of the valve seat can be facilitated by means of biting edges 11 or biting teeth, which permit a rapid and reliable mounting or clamping of the metering valve 6.

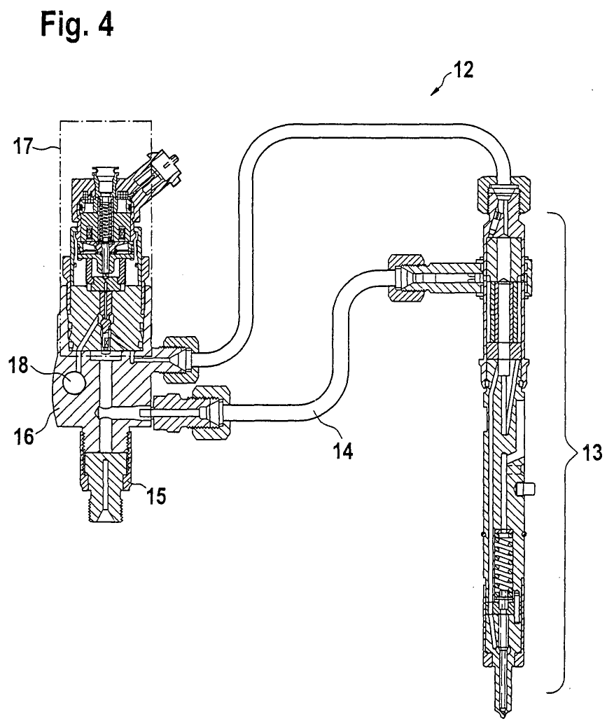

In FIG. 4, an injector 13 a pressure intensifier (pressure booster) is used in a fuel injection apparatus 12. The injector 13 is likewise connected to the common rail housing by means of a pressure line. If needed, an additional line 14 and a scavenging throttle 15 for refilling or scavenging the pressure intensifier can be connected to the common rail housing 16 in order to prevent cavitations or overheating. In one switching position of the metering valve 17, the pressure storage chamber 18 is connected to the pressure intensifier by means of the high-pressure line. In the other switched position, the high-pressure line to the pressure intensifier is connected to the pressure line 14 and the scavenging throttle 15.

1. A pressure-controlled fuel injection apparatus (1; 12) with a common rail, an injector (5), and a metering valve (6; 17) for controlling the injector (5), characterized in that the metering valve (6; 17) is integrated into the common rail.

2. The fuel injection apparatus according to claim 1, characterized in that the metering valve (6; 17) is a 3/2-port directional-control valve.

3. The fuel injection apparatus according to claim 1 or 2, characterized in that the metering valve (6; 17) is embodied as a module that can be screwed into a housing (3) of the common rail.

4. The fuel injection apparatus according to one or more of the preceding claims, characterized in that biting edges (11) are embodied on the valve seat of the metering valve (6; 17).

5. The fuel injection apparatus according to one or more of the preceding claims, characterized in that the valve seat of the metering valve (6; 17) is conically embodied.

6. The fuel injection apparatus according to one or more of the preceding claims, characterized in that other functional attachments are integrated into the common rail.
